(19) United States
(12) Patent Application Publication
(10) Pub. No.: US 2010/0030545 A1
(43) Pub. Date: Feb. 4, 2010

(54) PATTERN SHAPE PREDICTING METHOD AND PATTERN SHAPE PREDICTING APPARATUS

(76) Inventors: Taiga UNO, Ibaraki (JP); Toshiya Kotani, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/512,686

(22) Filed: Jul. 30, 2009

(30) Foreign Application Priority Data
Jul. 30, 2008 (JP) 2008-196428

(51) Int. Cl. G06F 17/50

(52) U.S. Cl. 703/13

(57) ABSTRACT

A pattern shape predicting method comprising: predicting, with simulation, an intensity distribution of a pattern image concerning a pattern shape of a pattern on substrate formed on a substrate based on pattern data; calculating a first pattern edge position from the intensity distribution of the pattern image; calculating a feature value of the intensity distribution of the pattern image in a predetermined range including the first pattern edge position; calculating a fluctuation amount of the first pattern edge position from the feature value using a correlation; and predicting a second pattern edge position taking into account the fluctuation amount with respect to the first pattern edge position.

### CROSS-REFERENCE TO RELATED APPLICATIONS

This application is based upon and claims the benefit of priority from the prior Japanese Patent Application No. 2008-196428, filed on Jul. 30, 2008; the entire contents of which are incorporated herein by reference.

### BACKGROUND OF THE INVENTION

1. Field of the Invention

The present invention relates to a pattern shape predicting method and a pattern shape predicting apparatus.

2. Description of the Related Art

In recent years, according to a reduction in size of semiconductor devices, line edge roughness (hereinafter, “roughness”) of patterns formed on masks and wafers becomes conspicuous. Fluctuation in dimensions of the patterns due to the roughness substantially affects device characteristics.

There are various causes of the roughness. It is known that, as described in SPIE Vol. 6519 651941 “Some Non-resist Component Contributions to LER and LWR in 193 nm Lithography”, a resist material, resist thickness, contrast during exposure, and the like are related to the roughness. Therefore, various measures such as improvement of a resist material and a process are examined as measures for reducing the roughness. In terms of development time and manufacturing cost, it is extremely important to predict the influence of edge roughness concerning an actual layout pattern before wafer processing is performed and find places that could pose problems.

As a method of predicting a shape of roughness, there is a method of simulating characteristics of a resist material and the like and stereoscopically (three-dimensionally) predicting a roughness shape. However, in this method, although highly accurate simulation is possible, time required for the simulation is extremely long. Therefore, the method is not suitable for simulating and evaluating an actual layout in a wide range.

In Proc. Of SPIE Vol. 5752 1227 “Characterization and Modeling of Line Width Roughness (LWR)”, a relation between line length and roughness (fluctuation σ) is represented by three parameters from an experiment result and a shape (roughness) of a line pattern is predicted by using the parameters. With the related art, a roughness shape of a line pattern can be predicted at high speed even if pattern data has large size.

However, in the related art, although a roughness shape concerning one-dimensional pattern arrangement (lines, spaces, and the like arranged in one direction) can be predicted, a roughness shape concerning two-dimensional pattern arrangement (lines, spaces, and the like arranged in a plurality of directions) a shape cannot be predicted.

### BRIEF SUMMARY OF THE INVENTION

A pattern shape predicting method according to an embodiment of the present invention comprises: predicting, with simulation, an intensity distribution of a pattern image concerning a pattern shape of a pattern on substrate formed on a substrate based on pattern data; calculating a first pattern edge position from the intensity distribution of the pattern image; calculating a feature value of the intensity distribution of the pattern image in a predetermined range including the first pattern edge position; calculating a fluctuation amount of the first pattern edge position from the feature value using a correlation; and predicting a second pattern edge position taking into account the fluctuation amount with respect to the first pattern edge position.

A pattern shape predicting apparatus according to an embodiment of the present invention comprises: an intensity-distribution calculating unit that predicts, with simulation, an intensity distribution of a pattern image concerning a pattern shape of a pattern on substrate formed on a substrate based on pattern data; a first-pattern-edge-position calculating unit that calculates a first pattern edge position from the intensity distribution of the pattern image; a feature-value calculating unit that calculates a feature value of the intensity distribution of the pattern image in a predetermined range including the first pattern edge position; a fluctuation-amount calculating unit that calculates a fluctuation amount of the first pattern edge position from the feature value using a correlation; and a second-pattern-edge-position calculating unit that predicts a second pattern edge position taking into account the fluctuation amount with respect to the first pattern edge position.

### BRIEF DESCRIPTION OF THE DRAWINGS

FIG. 1 is a block diagram of a configuration of a pattern shape predicting apparatus according to a first embodiment of the present invention;

FIG. 2 is a diagram of a hardware configuration of the pattern shape predicting apparatus;

FIG. 3 is a flowchart of a processing procedure for calculating correspondence relation (correlation) information;

FIG. 4 is a flowchart of a processing procedure for predicting a pattern shape;

FIG. 5 is a diagram of an example of an exposure mask;

FIG. 6 is a diagram of an example of a pattern formed on a wafer;

FIG. 7 is a graph of an example of a light intensity distribution;

FIG. 8 is a diagram for explaining an example of a method of calculating a standard deviation in a line pattern having same degrees of spaces on the left and right;

FIG. 9 is graph of an example of correspondence relation (correlation) information;

FIG. 10 is a diagram of an example of pattern data of a pattern as a target of shape prediction;

FIG. 11 is a diagram for explaining evaluation points arranged on pattern edges;

FIG. 12 is a diagram for explaining a line from which a light intensity distribution is extracted;

FIG. 13 is a graph for explaining a method of calculating the slope of light intensity;

FIG. 14 is a diagram for explaining processing for moving an evaluation point;

FIG. 15 is a diagram for explaining processing for generating a pattern shape;

FIG. 16 is a diagram of an example of a pattern shape predicted by the pattern shape predicting apparatus;

FIG. 17 is a diagram for explaining arrangement intervals of evaluation points;

FIG. 18 is a diagram for explaining an example of a method of dividing pattern edges; and

FIG. 19 is a diagram for explaining processing for moving an evaluation point.

### DETAILED DESCRIPTION OF THE INVENTION

Exemplary embodiments of the present invention are explained in detail below with reference to the accompanying drawings. The present invention is not limited by the embodiments.

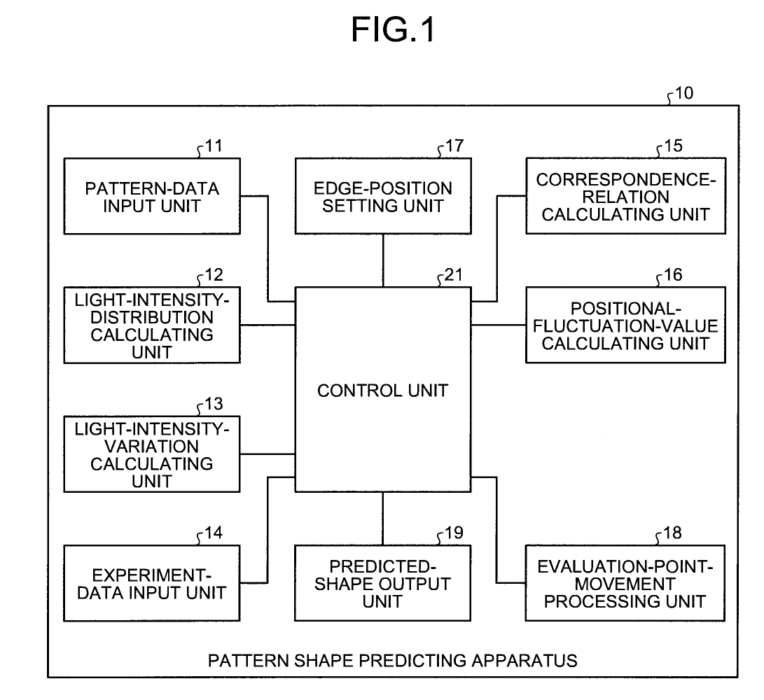

FIG. 1 is a block diagram of a configuration of a pattern shape predicting apparatus according to a first embodiment of the present invention. A pattern shape predicting apparatus 10 is an apparatus that predicts roughness of a pattern formed on a substrate such as a mask or a wafer. The pattern shape predicting apparatus 10 according to this embodiment predicts a pattern shape viewed from an upper side of the substrate. The pattern shape predicting apparatus 10 predicts a pattern shape by predicting a finish position of a pattern edge (an evaluation point) on the pattern. In the explanation of this embodiment, the substrate is a wafer. Therefore, the pattern shape predicting apparatus 10 according to this embodiment predicts a shape of a pattern formed on the wafer when a pattern on the mask is transferred onto the wafer.

The pattern shape predicting apparatus 10 includes a pattern-data input unit 11, a light-intensity-distribution calculating unit 12, a light-intensity-variation calculating unit 13, an experiment-data input unit 14, a correspondence-relation calculating unit 15, a positional-fluctuation-value calculating unit 16, an edge-position setting unit 17, an evaluation-point-movement processing unit 18, a predicted-shape output unit 19, and a control unit 21.

The pattern-data input unit 11 receives input of pattern data from an external device (a pattern data creating apparatus, etc.) and sends the pattern data to the light-intensity-distribution calculating unit 12 and the edge-position setting unit 17. The pattern data may be any data such as mask data including rendering data, design layout data of a semiconductor circuit, and data (a lithography target, etc.) obtained by subjecting the design layout data to layer arithmetic operation or transformation processing (proximity effect correction processing including resizing and OPC processing). In the following explanation, the pattern data is the design layout data. The pattern data input to the pattern-data input unit 11 includes pattern data for calculating correspondence relation information explained later (hereinafter, “pattern data for correspondence relation calculation “a”) and pattern data of a pattern as a shape prediction target (hereinafter, “shape predicting pattern data “b”).

The light-intensity-distribution calculating unit 12 performs exposure simulation using pattern data. The light-intensity-distribution calculating unit 12 calculates, with the exposure simulation, a light intensity distribution of exposure light irradiated on a wafer. In performing the exposure simulation using the pattern data for correspondence relation calculation “a”, the light-intensity calculating unit 12 sets various exposure conditions (a dose, a focus, etc.) and calculates a light intensity distribution corresponding to exposure conditions. The light-intensity-distribution calculating unit 12 sends the calculated light intensity distribution to the light-intensity-variation calculating unit 13. However, when a substrate as a target of shape prediction is present on the mask rather than the wafer, as the distribution calculated by the exposure simulation, an EB dose distribution is used instead of the light intensity distribution.

The light-intensity-variation calculating unit 13 as means for calculating a feature value of a pattern calculates information concerning the variation of light intensity in a pattern edge (a changing characteristic of the light intensity distribution) (a feature value of a light intensity distribution of a pattern image). The variation of the light intensity includes, for example, at least one of the slope of light intensity at the pattern edge, contrast of light intensity at the pattern edge, log slope of light intensity at the pattern edge, and a dose integral amount of exposure intensity. In the following explanation this embodiment, the variation of light intensity is the slope of light intensity at the pattern edge.

The light-intensity-variation calculating unit 13 sends the calculated light intensity variation (the slope of light intensity) to the correspondence-relation calculating unit 15 and the positional-fluctuation-value calculating unit 16. The light-intensity-variation calculating unit 13 sends the slope of light intensity calculated from the pattern data for correspondence relation calculation “a” to the correspondence-relation calculating unit 15 as a slope value for correspondence relation calculation (first light intensity information) “c”. The light-intensity-variation calculating unit 13 sends the slope of light intensity calculated from the pattern data for shape prediction “b” to the positional-fluctuation-value calculating unit 16 as a slope value for shape prediction (second light intensity information) “d”.

The edge-position setting unit 17 sets a plurality of evaluation points as targets of position prediction on pattern edges of the pattern data for correspondence relation calculation “a” and the pattern data for shape prediction “b”. For example, the edge-position setting unit 17 sets the evaluation points such that the evaluation points are arranged at equal intervals on the pattern edges. The edge-position setting unit 17 may arrange the evaluation points at arbitrary intervals according to the arrangement of a layout instead of arranging the evaluation points at equal intervals.

The experiment-data input unit 14 receives input of information (experiment data) concerning a shape (dimensions, a position, etc.) of a pattern formed on the wafer (a pattern on substrate) and sends the information to the correspondence-relation calculating unit 15. The experiment data is a pattern shape of an actual pattern transferred onto the wafer by using a mask pattern corresponding to the pattern data for correspondence relation calculation “a”. The experiment data is data obtained by actually measuring the actual pattern transferred onto the wafer (a pattern shape after development). In this embodiment, various exposure conditions are set in advance and pattern shapes corresponding to the exposure conditions are measured as experiment data. Exposure conditions in measuring the experiment data are the same as exposure conditions set in the light-intensity-distribution calculating unit 12.

The correspondence-relation calculating unit 15 calculates, from the experiment data sent from the experiment-data input unit 14, finish fluctuation in the pattern edge (a finish position) (a standard deviation σ1 of the finish position). The correspondence-relation calculating unit 15 calculates, as correspondence relation information, a correspondence relation between the standard deviation σ1 of the finish position and the slope value for correspondence relation calculation “c”. The correspondence relation information is an approximation formula (an approximation function) or the like matching the correspondence relation between the standard deviation σ1 of the finish position and the slope amount for correspondence relation calculation “c”. The correspondence-relation calculating unit 15 sends the calculated approximation formula to the positional-fluctuation-value calculating unit 16.

The positional-fluctuation-value calculating unit 16 calculates, based on the slope value for shape prediction “d” and the approximation formula, finish fluctuation (a standard deviation σ2 of the finish position) of a pattern edge corresponding to the slope value for shape prediction “d” for each of the evaluation points. The positional-fluctuation-value calculating unit 16 sends the calculated standard deviation σ2 of the finish position to the evaluation-point-movement processing unit 18.

The evaluation-point-movement processing unit 18 calculates a fluctuation amount of evaluation points (a finish fluctuation amount dX2) (a distance corresponding to a random number) from the standard deviation σ2 of the finish position using a normal random number. The evaluation-point-movement processing unit 18 derives a position of the pattern edge from optical image intensity calculated by the exposure simulation using the pattern data for shape prediction “b” and a slice level. The evaluation-point-movement processing unit 18 calculates, as a positional shift amount (a positional shift amount dX1), a difference between the derived position of the pattern edge and a position of the pattern edge corresponding to the pattern data for shape prediction “b”. The evaluation-point-movement processing unit 18 moves positions of the evaluation points set in pattern data by a distance obtained by adding up the calculated finish fluctuation amount dX2 and the calculated positional shift amount dX1. The evaluation-point-movement processing unit 18 moves the positions of the evaluation points relative to all the evaluation points set by the edge-position setting unit 17. The evaluation-point-movement processing unit 18 connects the moved evaluation points to generate a predicted pattern shape.

The predicted-shape output unit 19 outputs the pattern shape generated by the evaluation-point-movement processing unit 18 to an external device and a display device (a display unit 4 explained later) such as a liquid crystal monitor. The control unit 21 controls the pattern-data input unit 11, the light-intensity-distribution calculating unit 12, the light-intensity-variation calculating unit 13, the experiment-data input unit 14, the correspondence-relation calculating unit 15, the positional-fluctuation-value calculating unit 16, the edge-position setting unit 17, the evaluation-point-movement processing unit 18, and the predicted-shape output unit 19.

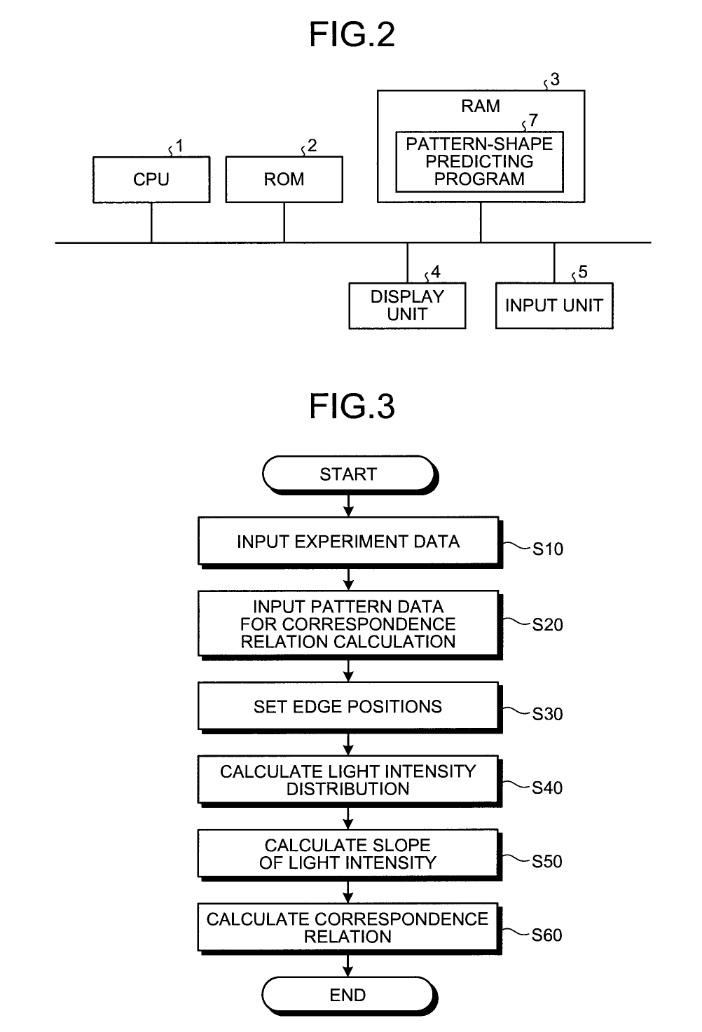

FIG. 2 is a diagram of a hardware configuration of the pattern shape predicting apparatus. The pattern shape predicting apparatus 10 includes a central processing unit (CPU) 1, a read only memory (ROM) 2, a random access memory (RAM) 3, a display unit 4, and an input unit 5. In the pattern shape predicting apparatus 10, the CPU 1, the ROM 2, the RAM 3, the display unit 4, and the input unit 5 are connected via a bus line.

The CPU 1 predicts a pattern shape using a pattern shape predicting program 7, which is a computer program for predicting a pattern shape. The display unit 4 is a display device such as a liquid crystal monitor and displays pattern data, a prediction result (a pattern shape), and the like based on an instruction from the CPU 1. The input unit 5 includes a mouse and a keyboard and receives input of instruction information (parameters and the like necessary for predicting a pattern shape) externally input from a user. The instruction information input to the input unit 5 is sent to the CPU 1.

The pattern shape predicting program 7 is stored in the ROM 2 and loaded to the RAM 3 via the bus line. The CPU 1 executes the pattern shape predicting program 7 loaded in the RAM 3. Specifically, in the pattern shape predicting apparatus 10, the CPU 1 reads out the pattern shape predicting program 7 from the ROM 2, expands the pattern shape predicting program 7 in a program storage area in the RAM 3, and executes various kinds of processing according to instruction input by the user from the input unit 5. The CPU 1 temporarily stores various data generated in the various kinds of processing in the data storage area formed in the RAM 3. The pattern shape predicting program 7 can be stored in a storage device such as a disk or can be loaded to the storage device such as a disk.

The pattern shape predicting program 7 executed by the pattern shape predicting apparatus 10 according to this embodiment has a module configuration including the units explained above (the pattern-data input unit 11, the light-intensity-distribution calculating unit 12, the light-intensity-variation calculating unit 13, the experiment-data input unit 14, the correspondence-relation calculating unit 15, the positional-fluctuation-value calculating unit 16, the edge-position setting unit 17, the evaluation-point-movement processing unit 18, the predicted-shape output unit 19, and the control unit 21). When the units are loaded onto a main storage device, the pattern-data input unit 11, the light-intensity-distribution calculating unit 12, the light-intensity-variation calculating unit 13, the experiment-data input unit 14, the correspondence-relation calculating unit 15, the positional-fluctuation-value calculating unit 16, the edge-position setting unit 17, the evaluation-point-movement processing unit 18, the predicted-shape output unit 19, and the control unit 21 are generated on the main storage device.

The pattern shape predicting program 7 executed by the pattern shape predicting apparatus 10 according to this embodiment can be stored on a computer connected to a network such as the Internet and provided by being downloaded through the network. The pattern shape predicting program 7 executed by the pattern shape predicting apparatus 10 according to this embodiment can be provided or distributed via the network such as the Internet. The pattern shape predicting program 7 according to this embodiment can be incorporated in a ROM or the like and provided to the pattern shape predicting apparatus 10.

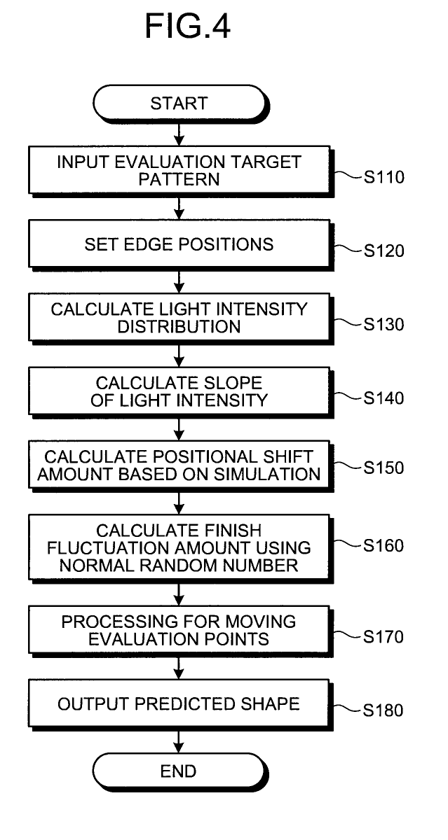

FIG. 3 is a flowchart of a processing procedure for calculating correspondence relation information (a pre-stage processing procedure) performed by the pattern shape predicting apparatus according to the first embodiment. FIG. 4 is a flowchart of a processing procedure for predicting a pattern shape (a post-stage processing procedure) performed by the pattern shape predicting apparatus according to the first embodiment.

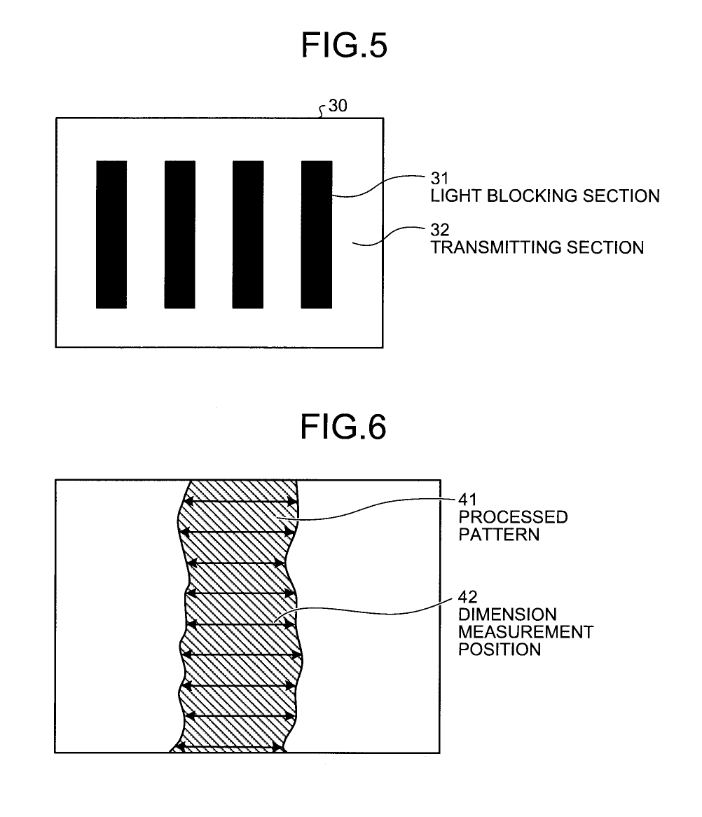

The pattern shape predicting apparatus 10 inputs experiment data, which is sent from an external device (a storage device for experiment data, etc.), to the experiment-data input unit 14 (step S10). The experiment data input to the experiment-data input unit 14 is sent to the correspondence-relation calculating unit 15. The experiment data input to the pattern shape predicting apparatus 10 is, for example, a pattern shape of a pattern formed on a wafer using an exposure mask 30 shown in FIG. 5.

The exposure mask 30 is a mask including a transmitting section 32 and a light blocking section 31. Lines and spaces (a semiconductor circuit pattern) such as a wiring pattern are formed by the transmitting section 32 and the light blocking section 31. The transmitting section 32 transmits light irradiated on the exposure mask 30 and the light blocking section 31 absorbs the light irradiated on the exposure mask 30.

When experiment data is measured, a pattern is exposed and transferred onto the wafer by using the exposure mask 30 and then the pattern is formed on a wafer obtained by processing the wafer by development, etching, and the like. Patterns are formed on the wafer under a plurality of conditions with a dose and a focus changed. Pattern dimensions of the patterns formed on the wafer are measured in a plurality of places. FIG. 6 is a diagram of an example of the patterns formed on the wafer. A pattern (a processed pattern 41) formed on the wafer has fluctuation in line width. When the pattern on the wafer is measured, a plurality of edge positions are set on the pattern and pattern dimensions among edge positions (dimension measurement positions 42) parallel in a latitudinal direction of the pattern are measured. Pattern dimensions (line width) in the dimension measurement positions 42 of the pattern on the wafer are measured among various edge positions and sent to the pattern shape predicting apparatus 10 as experiment data.

The pattern shape predicting apparatus 10 inputs the pattern data for correspondence relation calculation “a”, which is sent from the external device or the like, to the pattern-data input unit 11 (step S20). The pattern data input to the pattern shape predicting apparatus 10 is pattern data of the pattern formed on the exposure mask 30 used for the measurement of experiment data.

The edge-position setting unit 17 sets one or a plurality of evaluation points (edge positions) on the pattern edge of the pattern data for correspondence relation calculation “a” (step S30). The edge-position setting unit 17 selects a predetermined plurality of edge positions out of edge positions of which are measured as experiment data, and sets the selected edge positions as evaluation points.

The light-intensity-distribution calculating unit 12 performs exposure simulation using the pattern data for correspondence relation calculation “a” and calculates a light intensity distribution of exposure light irradiated on the wafer. The light-intensity-distribution calculating unit 12 sets various exposure conditions (conditions same as the exposure conditions used when the experiment data are measured) and calculates a light intensity distribution corresponding to the exposure conditions (step S40).

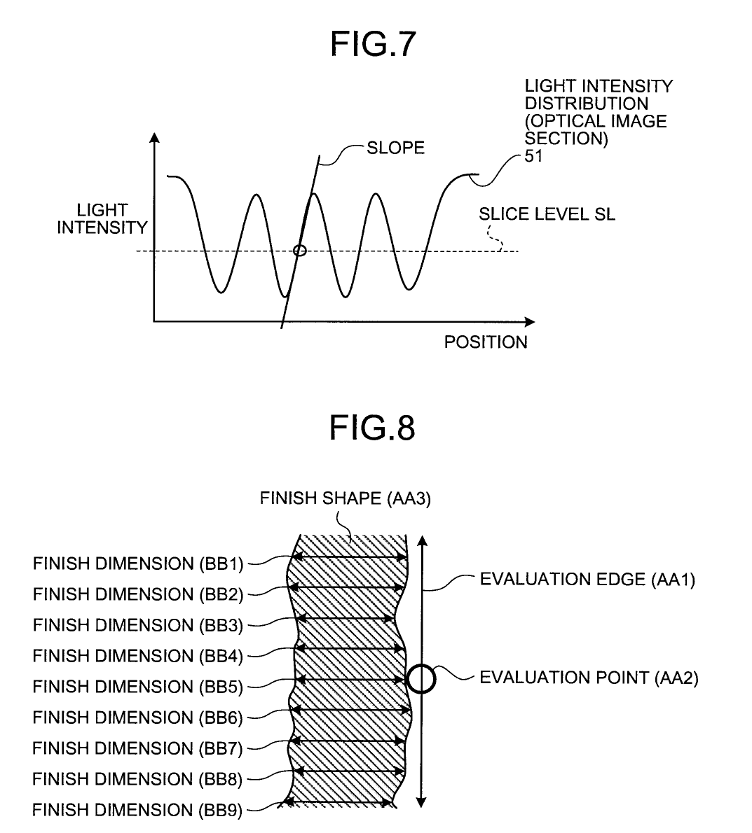

FIG. 7 is a graph of an example of a light intensity distribution. In FIG. 7, the ordinate indicates light intensity and the abscissa indicates a position on the wafer. A light intensity distribution (an optical image section) 51 in a latitudinal direction of, for example, a plurality of line patterns transferred onto the wafer shown in FIG. 5 is shown.

A light intensity position as a boundary of light intensity defining whether a pattern is formed on the wafer is a slice level SL. For example, a pattern is formed on the wafer at light intensity lower than the slice level SL. A point where the slice level SL and the light intensity distribution 51 overlap is a pattern edge. The light-intensity-distribution calculating unit 12 sends the calculated light intensity distribution to the light-intensity-variation calculating unit 13.

The light-intensity-variation calculating unit 13 calculates the slope of light intensity at the pattern edge using the light intensity distribution calculated by the light-intensity-distribution calculating unit 12 (step S50). Specifically, the light-intensity-variation calculating unit 13 calculates the slope of light intensity at the evaluation points set by the edge-position setting unit 17. The light-intensity-variation calculating unit 13 sends the calculated slope of the light intensity to the correspondence-relation calculating unit 15 as the slope value for correspondence relation calculation “c”.

The correspondence-relation calculating unit 15 calculates the standard deviation σ1 indicating finish fluctuation near a predetermined position of the pattern edge from the experiment data sent from the experiment-data input unit 14. Specifically, the correspondence-relation calculating unit 15 calculates the standard deviation σ1 of a finish position at each of the evaluation points set by the edge-position setting unit 17. The correspondence-relation calculating unit 15 calculates a correspondence relation between the standard deviation σ1 of the finish position and the slope value for correspondence relation calculation “c” as correspondence relation information (step S60).

FIG. 8 is a diagram for explaining an example of a method of calculating the standard deviation σ1 in a line pattern having same degrees of spaces on the left and right. A finish fluctuation amount (the standard deviation σ1 of a finish shape AA3) at an evaluation point AA2 (edge) set in an evaluation edge AA1 shown in FIG. 8 can be represented by the following Formula 1 from the principle of additivity of dispersion when a fluctuation amount of finish dimensions BB1 to BB9 is represented as a standard deviation value σBB:

$$\begin{matrix}Formula I & \\ σ 1 = \frac{σ BB}{\sqrt{2}} & ( 1 )\end{matrix}$$

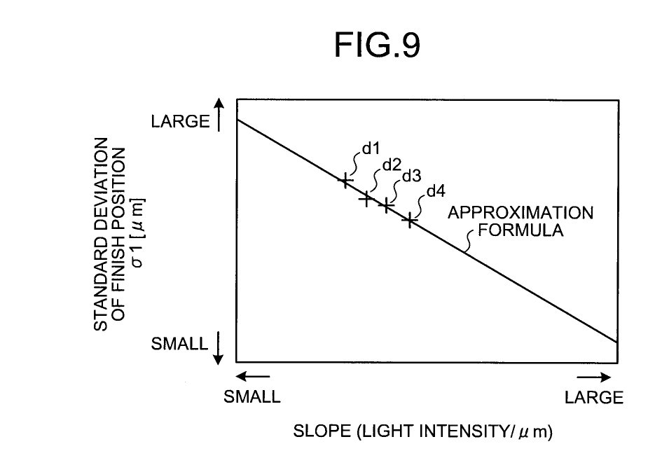

The correspondence-relation calculating unit 15 associates the standard deviation σ1 (experiment data) of the finish position and the slope value for correspondence relation calculation “c” (simulation data) under the same exposure conditions. The associated data is plotted on a graph in which the X axis indicates the slope of light intensity (the slope value for correspondence relation calculation “c”) and the Y axis indicates the standard deviation σ1 (fluctuation in an edge position) of the finish position. FIG. 9 is a diagram of an example of correspondence relation information. In FIG. 9, a graph in which a correspondence relation between the slope of light intensity and the standard deviation σ1 of the finish position is plotted is shown. The correspondence-relation calculating unit 15 plots the correspondence relation between the slope of light intensity and the standard deviation σ1 of the finish position in order in such a manner as a correspondence relation d1, a correspondence relation d2, and a correspondence relation d3. The correspondence-relation calculating unit 15 calculates, for each of exposure conditions, an approximation formula corresponding to the correspondence relation between the standard deviation σ1 of the finish position and the slope of light intensity based on a plotted plurality of coordinates.

For example, when there is a linear relation between the slope of light intensity and the standard deviation σ1 of the finish position, the correspondence-relation calculating unit 15 approximates the correspondence relation between the slope of light intensity and the standard deviation σ1 of the finish position with a formula of a linear function (σ1(x)=ax+b). The correspondence-relation calculating unit 15 sends the calculated approximation formula to the positional-fluctuation-value calculating unit 16 as correspondence relation information. The correspondence relation between the slope of light intensity and the standard deviation σ1 of the finish position is represented by a linear expression, a polynomial, or the like.

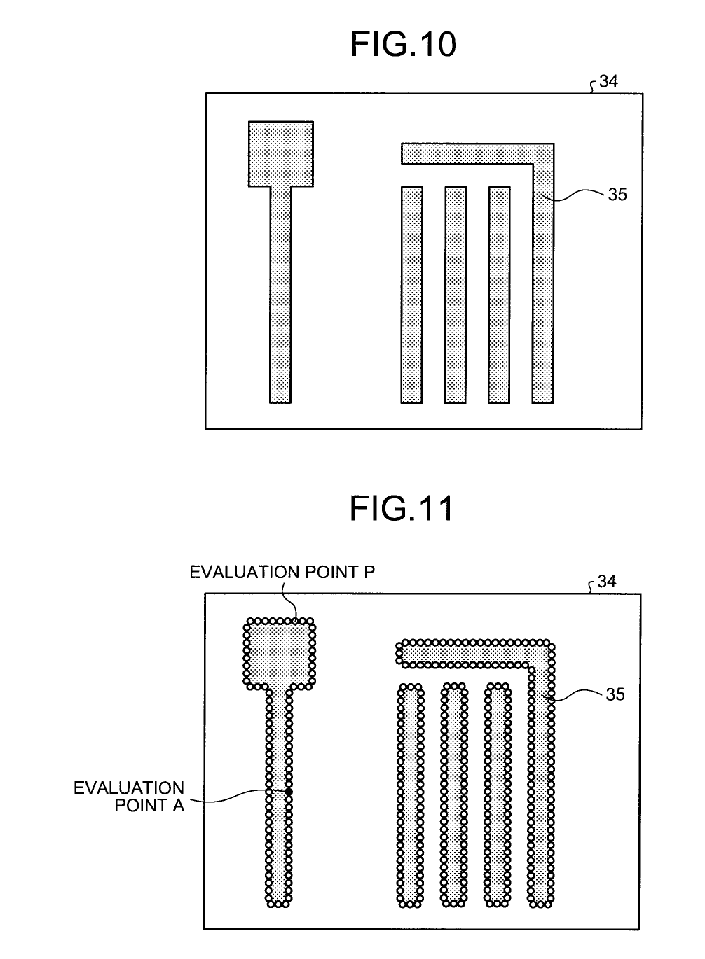

After finishing the prior preparation (the processing for calculating correspondence relation information) explained above, the pattern shape predicting apparatus 10 starts shape prediction for a pattern as a target of shape prediction. FIG. 10 is a diagram of an example of pattern data of the pattern as the target of shape prediction. Various patterns are formed on a mask by the transmitting section 34 and the light blocking section 35. The pattern shape predicting apparatus 10 predicts a pattern shape of a pattern formed on the wafer using this mask pattern data.

First, the pattern shape predicting apparatus 10 inputs the pattern data for shape prediction “b”, which is sent from an external device or the like, to the pattern-data input unit 11 (step S110). The edge-position setting unit 17 sets a plurality of evaluation points on a pattern edge of the pattern data for shape prediction “b” (step S120). For example, as shown in FIG. 11, the edge-position setting unit 17 finely divides pattern edges (edge lines) of the patterns at predetermined intervals and sets evaluation points P in the centers of the divided pattern edges. Thereafter, the pattern shape predicting apparatus 10 calculates the slope of light intensity and the like at the evaluation points P and predicts positions of the evaluation points P on the wafer. In the following explanation, the slope of light intensity and the like at an evaluation point A (one example of evaluation points P) shown in FIG. 11 is calculated and prediction of a position of the evaluation point A is performed.

The light-intensity-distribution calculating unit 12 performs exposure simulation using the pattern data for shape prediction “b” and calculates a light intensity distribution of exposure light irradiated on the wafer. The light-intensity-distribution calculating unit 12 sets predetermined exposure condition (exposure condition designated by the user, etc.) and calculates a light intensity distribution (step S130). Also if finish positions under plural exposure conditions are wanted to be predicted and evaluated, those plural conditions can be set in this unit.

The light-intensity-variation calculating unit 13 calculates the slope of light intensity at the evaluation point A using the light intensity distribution calculated by the light-intensity-distribution calculating unit 12 (step S140).

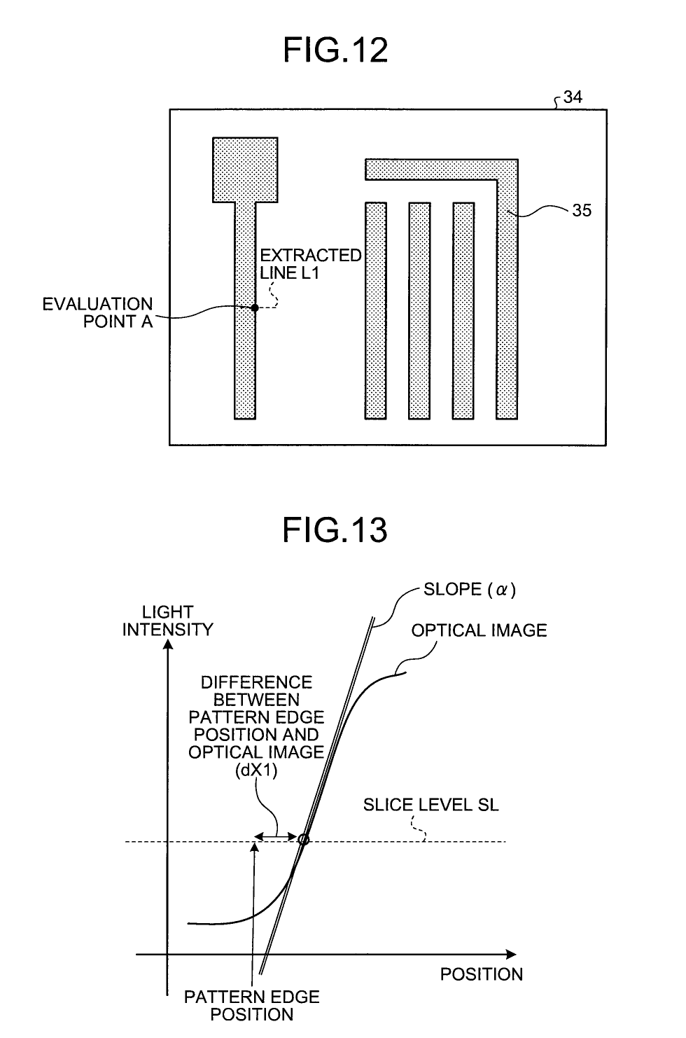

FIG. 12 is a diagram for explaining a line for extracting a light intensity distribution. FIG. 13 is a graph for explaining a method of calculating the slope of light intensity.

As shown in FIG. 12, first, the light-intensity-variation calculating unit 13 extracts, as an extracted line L1, a line (a line segment) passing through the evaluation point A and extending in a direction perpendicular to an edge line direction. The light-intensity-variation calculating unit 13 one-dimensionally slices a light intensity distribution of the extracted line L1. An optical image indicating the sliced light intensity distribution is, for example, an optical image (a light-intensity profile) shown in FIG. 13. The light-intensity-variation calculating unit 13 finds a crossing point of the slice level SL and the line of the optical image and calculates the slope (α) of the optical image in that place (point).

The light-intensity-variation calculating unit 13 sends the slope of light intensity, which is calculated from the pattern data for shape prediction “b”, to the positional-fluctuation-value calculating unit 16 as the slope value for shape prediction “d”. The positional-fluctuation-value calculating unit 16 calculates finish fluctuation (a standard deviation σ2 of a finish position) of the evaluation point A corresponding to the slope value for shape prediction “d” based on the slope value for shape prediction “d” and the approximation formula calculated by the correspondence-relation calculating unit 15. The positional-fluctuation-value calculating unit 16 sends the calculated standard deviation σ2 to the evaluation-point-movement processing unit 18. Specifically, the positional-fluctuation-value calculating unit 16 calculates the standard deviation σ2 of the finish position at the evaluation point A using the slope α calculated by the light-intensity-variation calculating unit 13 and the approximation formula calculated by the correspondence-relation calculating unit 15 (the approximation formula corresponding to the exposure conditions designated by the user).

The evaluation-point-movement processing unit 18 derives a position of the evaluation point A on the wafer from the light intensity distribution calculated by the exposure simulation using the pattern data for shape prediction “b” and the slice level. The evaluation-point-movement processing unit 18 calculates a difference between the position of the evaluation point A on the wafer and a position (a logical position without positional shift) of the pattern edge corresponding to the pattern data for shape prediction “b” as a positional shift amount dX1 (a positional shift amount based on the exposure simulation) of the evaluation point A as shown in FIG. 13 (step S150).

The evaluation-point-movement processing unit 18 calculates a finish fluctuation amount dX2 of the evaluation point A from the standard deviation σ2 of the finish position using a normal random number (step S160). The finish fluctuation amount dX2 of the evaluation point A is a statistical positional shift amount calculated based on a positional shift distribution (a normal distribution, etc.) of the finish position of the evaluation point A.

The evaluation-point-movement processing unit 18 moves the position of the evaluation point A set in the pattern data by a distance obtained by adding up the calculated finish fluctuation amount dX2 and the calculated positional shift amount dX1 (step S170).

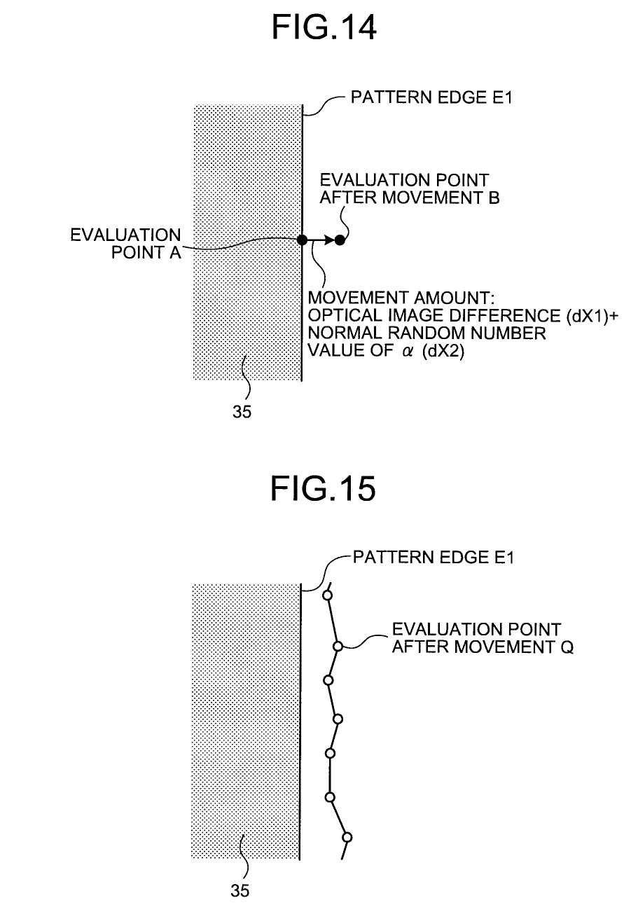

FIG. 14 is a diagram for explaining processing for moving the evaluation point A. As shown in the figure, the evaluation point A on a pattern edge E1 is moved in a direction perpendicular to the pattern edge E1 by the distance obtained by adding up the finish fluctuation amount dX2 (a normal random number value of the slope a) and the positional shift amount dX1 (an optical image difference). Consequently, the evaluation point A is moved to a position of an evaluation point B after the movement. The position of the evaluation point B after the movement is a predicted position of the evaluation point A when the pattern is formed on the wafer.

About all the remaining evaluation points P set by the edge position setting unit 17, their finish positions are calculated using the same way which is described above (like the example of the evaluation point A through S130 to S170).

Thereafter, the evaluation-point-movement processing unit 18 moves the positions relative to all the evaluation points P set by the edge-position setting unit 17. Thereafter, the evaluation-point-movement processing unit 18 connects the moved evaluation points P to generate a predicted pattern shape.

FIG. 15 is a diagram for explaining processing for generating a pattern shape. The evaluation-point-movement processing unit 18 moves the evaluation points P on the pattern edge E1 in the direction perpendicular to the pattern edge E1 by the distance obtained by adding up the finish fluctuation amount dX2 and the positional shift amount dX1. Consequently, the evaluation points P are moved to positions of evaluation points Q after the movement. The evaluation-point-movement processing unit 18 generates a pattern shape by connecting the evaluation points Q after the movement adjacent to one another on the same pattern edge. The pattern shape generated by the evaluation-point-movement processing unit 18 is a predicted shape of the pattern formed on the wafer by the pattern data shown in FIG. 10.

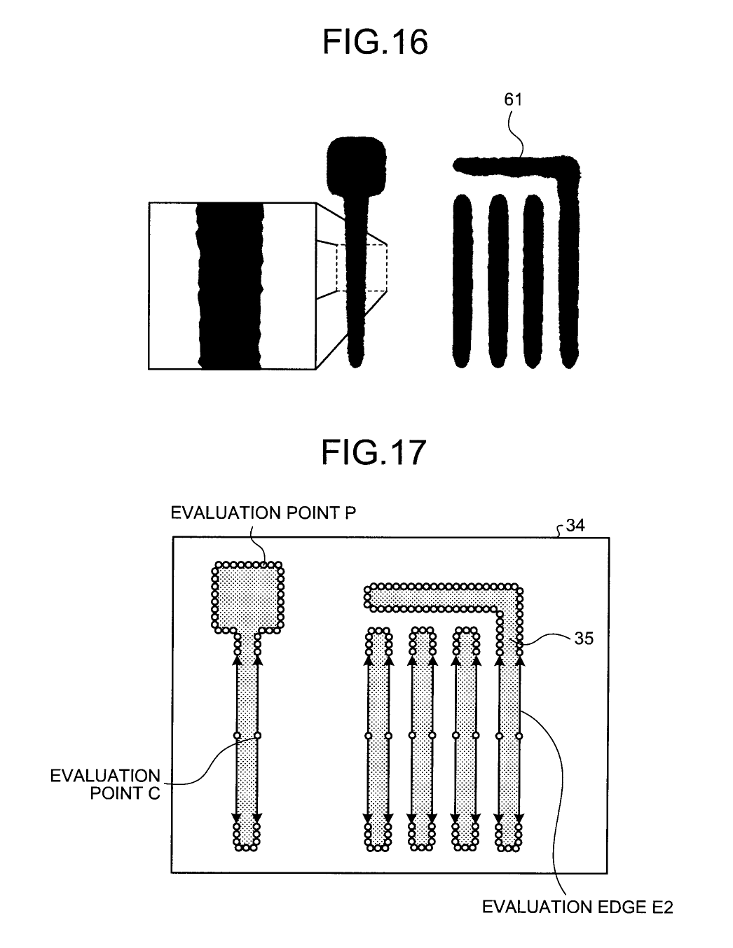

The predicted-shape output unit 19 outputs the pattern shape (the predicted shape) generated by the evaluation-point-movement processing unit 18 to the external device or the display device such as the liquid crystal monitor (step S180). FIG. 16 is a diagram of an example of the pattern shape predicted by the pattern shape predicting apparatus. As shown in the figure, a pattern shape 61 predicted by the pattern shape predicting apparatus 10 has a pattern edge having unevenness (line edge roughness).

Quality inspection for the mask, finish quality inspection on the wafer, and the like are performed based on the pattern shape predicted in this way. The pattern shape predicting apparatus 10 predicts a pattern shape for each of layers in a semiconductor manufacturing process. When the mask is rejected in the quality inspection for the mask, the finish quality inspection on the wafer, or the like, design layout data is changed or proximity effect correction processing including OPC processing or the like is performed. Thereafter, the pattern shape predicting apparatus 10 predicts a pattern shape using pattern data subjected to the design change, the proximity effect correction processing, or the like. The quality inspection is performed again. A semiconductor device is manufactured by using a mask that passes the quality inspection or a mask on which mask data subjected to OPC is formed.

In the explanation of this embodiment, the correspondence relation information is the approximation formula matching the correspondence relation between the standard deviation σ1 of the finish position and the slope of light intensity. However, the correspondence relation information can be an information table indicating the correspondence relation between the standard deviation σ1 of the finish position and the slope of light intensity.

In the explanation of this embodiment, the fluctuation amount of the evaluation point is calculated from the standard deviation σ2 of the finish position by using the normal random number (the feature value concerning the distribution of the finish position) (the random number corresponding to the distribution of the finish point). However, the fluctuation amount of the evaluation point can be calculated by using other random numbers other than the normal random number. For example, the evaluation-point-movement processing unit 18 can calculate the fluctuation amount of the evaluation point using a binomial random number, an exponential random number, a Poisson random number, and the like.

In this embodiment, the fluctuation is represented as the normal distribution. However, the fluctuation can be distributions other than the normal distribution. Methods of generating a random number matching the distributions are applied to random number generation. As another method, a database of experiment values can be formed to extract a value from the database at random.

In the explanation of this embodiment, the correspondence relation between the slope of light intensity and the standard deviation σ1 of the finish position is approximated by the formula of the linear function. However, the correspondence relation can be approximated by other approximation formulas such as a quadratic function and a polynomial.

In this embodiment, the simple pattern of lines and spaces is used when the value of the standard deviation σ1 of the finish position is calculated. However, to improve accuracy of the approximation formula, various patterns can be used. For example, variations of the width of lines and spaces can be increased to increase the number of samples. A two-dimensional pattern (a group of patterns in which a longitudinal direction of lines is arranged in a plurality of directions in a mask surface) can be used.

In the explanation of this embodiment, the correspondence relation is calculated based on the pattern shape of lines and spaces. However, pattern shapes other than the lines and spaces can be used. In particular, in a contact hole layer, prediction accuracy can be improved if a contact hole pattern to be actually applied is used as experiment data.

In the explanation of this embodiment, after the experiment data is input to the pattern shape predicting apparatus 10, the pattern data for correspondence relation calculation “a” is input. However, the experiment data can be input to the pattern shape predicting apparatus 10 at any timing before correspondence relation information is calculated.

In the explanation of this embodiment, the pattern shape predicting apparatus 10 calculates the correspondence relation information. However, the correspondence relation information can be calculated by other apparatuses. When the correspondence relation information is calculated by another apparatus, the pattern shape predicting apparatus 10 does not have to include the experiment-data input unit 14 and the correspondence-relation calculating unit 15. The other apparatus includes the pattern-data input unit 11, the light-intensity-distribution calculating unit 12, the light-intensity-variation calculating unit 13, the experiment-data input unit 14, the correspondence-relation calculating unit 15, and the edge-position setting unit 17.

In the explanation of this embodiment, the finish shape of the pattern generated by the shape prediction is output. However, it is not always necessary to output the pattern shape having uneven edges (using the normal random number).

For example, when it is an object to evaluate a fluctuation degree (a fluctuation amount) of an edge position in a pattern edge, the standard deviation σ2 of a finish position of the pattern edge only has to be output. The pattern shape predicting apparatus 10 only has to select and output information corresponding to evaluation content.

For example, the pattern shape predicting apparatus 10 can calculate 3σ as finish fluctuation of the pattern edge and output a pattern shape obtained by adding 3σ to the positional shift amount dX1 or a pattern shape obtained by subtracting 3σ from the positional shift amount dX1. The pattern shape output in this way can be input to an apparatus such as a design rule checker (DRC) to cause the apparatus to detect line width or a place where an error (short circuit, rupture, etc.) is highly likely to occur.

AND (one of the layer operations) of roughness shapes among a plurality of electrically connected layers can be calculated to check an area. This makes it possible to check an electric characteristic of a semiconductor device.

The standard deviation σ2 of the finish position obtained from a measured roughness shape or a correspondence relation can be input to a device simulator to verify a transistor characteristic, a wiring capacity, and the like using the device simulator.

Etching simulation can be performed by using the predicted roughness shape to detect a place where an error is highly likely to occur with respect to a post-processing shape. This makes it possible to easily detect, for example, a place of an error that occurs during a sidewall process, double exposure (double transfer) process, and double patterning process.

The pattern shape predicting apparatus 10 can specify an allowable roughness amount on a mask based on a relation between a roughness shape of a pattern formed on the mask and a roughness shape of a pattern formed on a wafer. Specifically, the pattern shape predicting apparatus 10 predicts a roughness shape of a pattern formed on the mask using the EB simulation and performs exposure simulation using the mask. Then, the pattern shape predicting apparatus 10 calculates, from a pattern shape on the wafer obtained by the exposure simulation and the predicted pattern shape on the mask, a degree of the influence of the roughness shape on the mask on the roughness shape of the pattern formed on the wafer (a mask roughness influence degree) and specifies an allowable roughness amount on the mask based on a calculation result.

The pattern shape predicting apparatus 10 can calculate a difference between a roughness fluctuation amount on the wafer due to the mask roughness influence degree and a roughness fluctuation amount of a pattern actually formed on the wafer and calculate a roughness fluctuation amount due to exposure. Roughness on the wafer calculated by the method in the past is roughness including mask roughness. The pattern shape predicting apparatus 10 separately calculates the roughness due to exposure on the wafer and the mask roughness. Therefore, it is possible to accurately predict the roughness on the wafer including the influence of the mask roughness

Lithography conditions (wavelength, NA, σ, and an illumination shape) can be determined or OPC can be performed based on calculated finish fluctuation of a pattern edge such that dimensions after development added with roughness is within a predetermined allowable value.

It is also conceivable to use the pattern shape predicting apparatus 10 to determine lithography conditions under which finish fluctuation of a pattern edge (a fluctuation amount of optical image intensity slope) is small even when a dose and a focus are varied.

In the explanation of this embodiment, the light intensity distribution of the exposure light irradiated on the wafer is calculated by the exposure simulation. However, simulation processing only has to be process simulation that takes into account at least one of a mask process, an EB rendering process, an exposure process, an etching process, a slimming process, and a deposition process.

As explained above, according to the first embodiment, the pattern shape is predicted by using the correspondence relation between the finish fluctuation in the pattern edge and the slope of light intensity. Therefore, it is possible to quickly and accurately perform shape prediction taking into account fluctuation in edge finish. This makes it possible to accurately predict, in a short time, roughness in a substrate plane of a pattern shape formed on a substrate.

The finish fluctuation of the pattern edge (the standard deviation σ2 of the finish position) corresponding to the slope value for shape prediction “d” is calculated for each of the evaluation points using the table or the approximately function of the relation obtained from the empirical standard deviation σ1 and the exposure-simulated intensity slope corresponding the empirical pattern data. This makes it possible to perform highly accurate shape prediction.

The fluctuation amounts of the evaluation points are calculated from the standard deviation σ2 of the finish position by using the normal random number. Therefore, it is possible to impart fluctuation corresponding to the standard deviation σ2 of the finish position to a finish position to be predicted. This makes it possible to represent a realistic finish shape of a pattern.

In a second embodiment of the present invention, a representative evaluation point is set out of a plurality of evaluation points continuously adjacent to one another and the standard deviation σ2 of a finish position at this evaluation point is calculated.

In the second embodiment, shape prediction for a pattern is performed by using the pattern shape prediction apparatus 10 having a configuration same as that in the first embodiment. Therefore, explanation of the configuration of the pattern shape predicting apparatus 10 is omitted.

A processing procedure for calculating correspondence relation information according to the second embodiment is the same as the processing procedure for calculating correspondence information according to the first embodiment explained with reference to FIG. 3. Therefore, explanation of the processing procedure is omitted. A processing procedure for predicting a pattern shape according to the second embodiment is explained below. Explanation of a procedure for performing processing same as the processing procedure for predicting a pattern shape explained in the first embodiment is omitted.

The pattern shape predicting apparatus 10 inputs the pattern data for shape prediction “b”, which is sent from an external device or the like, to the pattern-data input unit 11. The edge-position setting unit 17 sets a plurality of evaluation points on a pattern edge of the pattern data for shape prediction “b”. The edge-position setting unit 17 according to this embodiment adjusts arrangement intervals of the evaluation points P according to positions of the pattern edge.

FIG. 17 is a diagram for explaining arrangement intervals of evaluation points. For example, in sections where an arrangement environment of adjacent patterns does not change such as the centers of lines and spaces, even if a plurality of the evaluation points P are finely arranged, there is no difference in the slope of light intensity between the adjacent evaluation points P or the difference is negligibly small. The edge-position setting unit 17 elongates evaluation edges E2 for such sections where there is no difference in the slope of light intensity and sets a predetermined evaluation point as one representative point. The evaluation edges E2 are edge lines (line segments) after fragmentation of a pattern edge fragmented by the edge-position setting unit 17. In FIG. 17, evaluation edges arranged in the centers of the edges especially seemed like lines and spaces are indicated by the evaluation edges E2 and the other evaluation edges are not shown.

The edge-position setting unit 17 sets the evaluation points P in the centers of the evaluation edges E2 fragmented at various intervals. In FIG. 17, evaluation points C in the elongated evaluation edges E2 are arranged in the centers of line patterns.

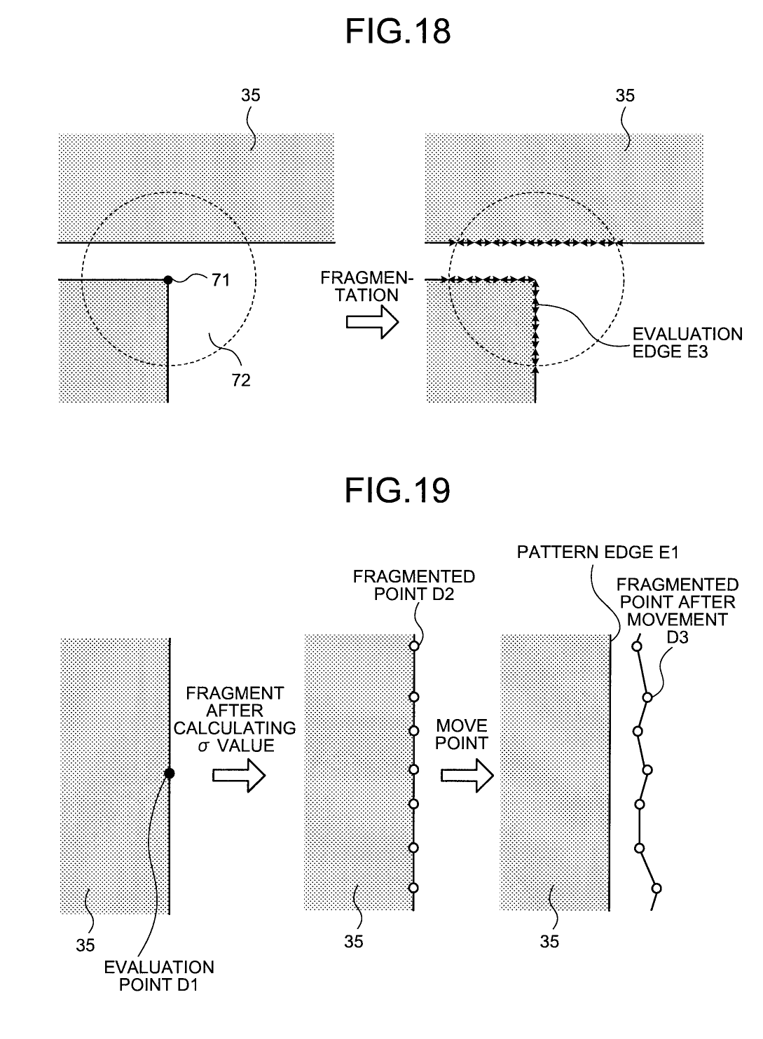

The edge-position setting unit 17 can set various methods as a method of dividing pattern edges. FIG. 18 is a diagram for explaining an example of the method of dividing pattern edges.

The edge-position setting unit 17 arranges edge positions on pattern edges at various intervals corresponding to the edge positions. Specifically, the edge-position setting unit 17 finely divides pattern edges present within a predetermined distance from a corner 71 of a pattern (in an area 72) and roughly divides the other pattern edges. In other words, the edge-position setting unit 17 sets short evaluation edges E3 near the corner 71 of the pattern and sets long evaluation edges in the other sections.

In setting the long evaluation edges, first, the edge-position setting unit 17 sets short evaluation edges on the pattern edges such that evaluation points are arranged, for example, at equal intervals as in the first embodiment. The edge-position setting unit 17 selects a predetermined number of adjacent evaluation edges among the evaluation edges located in areas other than the area 72 and sets an edge line formed by connecting the selected evaluation edges in the long evaluation edges. The edge-position setting unit 17 selects one representative point (an evaluation point in the center) out of evaluation points on the selected evaluation edges and sets only the selected one representative point as an evaluation point on the long evaluation edges. The edge-position setting unit 17 excludes the unselected evaluation points from the evaluation points. In setting the long evaluation edges, the edge-position setting unit 17 can exclude all evaluation points on the short evaluation edges from the evaluation points and set new evaluation points in the centers of the long evaluation edges instead of the exclusion of those short evaluation points.

In the explanation of this embodiment, the evaluation edges are set to be arranged at equal intervals in predetermined width. However, it is not always necessary to arrange the evaluation edges at equal intervals. It is also conceivable to arbitrarily set the width of the evaluation edges.

Thereafter, the light-intensity-variation calculating unit 13 calculates light intensity distributions at the evaluation points according to a processing procedure same as the processing procedure for predicting a pattern shape explained in the first embodiment and calculates the slope of light intensity at the evaluation point.

The evaluation-point-movement processing unit 18 calculates positional shift amounts dX1 of the evaluation points P and finish fluctuation amounts dX2 of the evaluation points P. Thereafter, the evaluation-point-movement processing unit 18 moves positions of evaluation points set in the pattern data by a distance obtained by adding up the calculated finish fluctuation amounts dX2 and the calculated positional shift amounts dX1. The evaluation-point-movement processing unit 18 calculates the finish fluctuation amount dX2 for each of the evaluation points on the short evaluation edges (each of the evaluation points before the connection of the evaluation edges) and moves the positions of the evaluation points.

FIG. 19 is a diagram for explaining the movement of the positions of the evaluation points. When the positions of the evaluation points on the short evaluation edges are moved, the pattern shape predicting apparatus 10 according to this embodiment moves the positions of the evaluation points after increasing the number of evaluation points. In other words, the evaluation points on the long evaluation edges are set at a plurality of evaluation points on the short evaluation edges not yet replaced with long evaluation edges such that the evaluation points are a plurality of evaluation points arranged to be adjacent to one another on the pattern edges. The positions of the evaluation points set again are moved.

For example, when one representative point is selected out of five evaluation points, the representative point is reset to the five evaluation points, a normal random number is calculated from the standard deviation σ2 of the finish position for each of the evaluation points, and about each evaluation points the finish fluctuation amount dX2 of the evaluation point is calculated respectively.

As another kind of means, it is also conceivable to fragment a long evaluation edge, generate a plurality of short evaluation edges anew, and move evaluation points on the short evaluation edges. In this embodiment, a method of fragmenting a long evaluation edge into a plurality of short evaluation edges anew is explained.

In FIG. 19, an evaluation point on a long evaluation edge is indicated by an evaluation point D1. In moving the evaluation point D1, the evaluation-point-movement processing unit 18 fragments an evaluation edge on which the evaluation point D1 is arranged and sets a plurality of evaluation points (fragmented points D2). Dimensions of evaluation edges on which the fragmented points D2 are arranged are substantially the same as those of the short edges explained with reference to FIG. 11.

The evaluation-point-movement processing unit 18 calculates normal random numbers from the standard deviation σ2 of the finish position calculated at the evaluation point D1 concerning the plural fragmented points D2 and calculates the finish fluctuation amounts dX2 of the fragmented points D2. The evaluation-point-movement processing unit 18 moves the fragmented points D2 using the finish fluctuation amounts dX2 (which are calculated on each fragmented points D2), respectively. In FIG. 19, the fragmented points after the movement are indicated as fragmented points after movement D3.

As explained above, according to the second embodiment, the exposure simulation and the calculation of the standard deviation σ2 of the finish position only have to be performed for the representative point. Therefore, it is possible to perform quick pattern shape prediction without deteriorating accuracy of shape prediction.

Further, a plurality of evaluation points are generated from the evaluation point on the evaluation edge as the representative point and the finish fluctuation amount dX2 is calculated for each of the evaluation points. Therefore, it is possible to easily perform highly accurate prediction of a pattern shape.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A pattern shape predicting method comprising:
predicting, with simulation, an intensity distribution of a pattern image concerning a pattern shape of a pattern on substrate formed on a substrate based on pattern data;
calculating a first pattern edge position from the intensity distribution of the pattern image;
calculating a feature value of the intensity distribution of the pattern image in a predetermined range including the first pattern edge position;
calculating a fluctuation amount of the first pattern edge position from the feature value using a correlation; and
predicting a second pattern edge position taking into account the fluctuation amount with respect to the first pattern edge position.

2. The pattern shape predicting method according to claim 1, wherein processing for calculating the correlation includes:
measuring a pattern shape of the pattern on substrate actually formed on the substrate and calculating, based on a measurement result, fluctuation in a finish position of the pattern shape in an edge position of the pattern on substrate as fluctuation information;
calculating, with simulation, an intensity distribution of the pattern image from pattern data for forming the pattern on substrate;
calculating a feature value of the intensity distribution of the pattern image in a range including an edge position corresponding to the edge position of the pattern on substrate in which the fluctuation information is calculated; and
calculating a correspondence relation between the fluctuation information and the feature value as a correlation.

3. The pattern shape predicting method according to claim 2, wherein
the pattern on substrate is actually formed on the substrate under a plurality of conditions,
the feature values are simulated under the each conditions, and
the each correlations are calculated for each of the conditions by using the fluctuation information and the feature value calculated under same condition.

4. The pattern shape predicting method according to claim 1, wherein the correlation is an approximation formula indicating the correspondence relation between the fluctuation information and the feature value.

5. The pattern shape predicting method according to claim 2, wherein the correlation is an approximation formula indicating the correspondence relation between the fluctuation information and the feature value.

6. The pattern shape predicting method according to claim 1, wherein the fluctuation amount is calculated as a distribution of statistical shift.

7. The pattern shape predicting method according to claim 1, wherein
the fluctuation amount is a fluctuation range of the finish edge positions of the first pattern edge, and
the second pattern edge position is an edge position range obtained by adding the fluctuation range to the first pattern edge position.

8. The pattern shape predicting method according to claim 1, wherein
the fluctuation amount is a fluctuation range of the finish edge positions of the first pattern edge, and
the second pattern edge position is an edge position obtained by adding a normal random number value of the fluctuation amount to the first pattern edge position.

9. The pattern shape predicting method according to claim 1, wherein the first pattern edge position is calculated with respect to a representative edge point selected out of edge points in a predetermined range among a plurality of edge points arranged at predetermined intervals on edge lines of the pattern on substrate.

10. The pattern shape predicting method according to claim 9, wherein the representative edge point is selected out of continuous edge points present in an area that is a predetermined distance or more apart from a pattern corner.

11. The pattern shape predicting method according to claim 8, wherein the second pattern edge position is calculated with respect to the edge points in the predetermined range by using the first pattern edge position.

12. The pattern shape predicting method according to claim 1, wherein the first pattern edge position is calculated for each of edge points arranged at intervals corresponding to the environment of the position of the edge line on the edge line of the pattern on substrate.

13. The pattern shape predicting method according to claim 1, wherein the second pattern edge position is predicted by the fluctuation amount using the correlation obtained from the plurality of kinds of pattern data.

14. The pattern shape predicting method according to claim 1, wherein the pattern data is data obtained by applying proximity effect correction processing including OPC processing to a semiconductor circuit pattern.

15. The pattern shape predicting method according to claim 1, wherein the first pattern edge position is calculated for each of edge points arranged at predetermined intervals on edge lines of the pattern on substrate.

16. The pattern shape predicting method according to claim 1, wherein the feature value includes at least one of contrast, slope, and log slope of an exposure intensity distribution near an edge position, a dose integral amount of exposure intensity.

17. A pattern generating method comprising:
predicting, with simulation, an intensity distribution of a pattern image concerning a pattern shape of a pattern on substrate formed on a substrate based on pattern data;
calculating a first pattern edge position from the intensity distribution of the pattern image;
calculating a feature value of the intensity distribution of the pattern image in a predetermined range including the first pattern edge position;
calculating a fluctuation amount of the first pattern edge position from the feature value using a correlation;
predicting a second pattern edge position taking into account the fluctuation amount with respect to the first pattern edge position;
predicting the pattern shape using the predicted second pattern edge position; and
performing quality inspection for the predicted pattern shape and changing the pattern data when the pattern shape is rejected in the quality inspection.

18. The pattern generating method according to claim 17, wherein processing for calculating the correlation includes:
measuring a pattern shape of the pattern on substrate actually formed on the substrate and calculating, based on a measurement result, fluctuation in a finish position of the pattern shape in an edge position of the pattern on substrate as fluctuation information;
calculating, with simulation, an intensity distribution of the pattern image from pattern data for forming the pattern on substrate;
calculating a feature value of the intensity distribution of the pattern image in a range including an edge position corresponding to the edge position of the pattern on substrate in which the fluctuation information is calculated; and
calculating a correspondence relation between the fluctuation information and the feature value as a correlation.

19. The pattern generating method according to claim 18, wherein
the pattern on substrate is actually formed on the substrate under a plurality of conditions,
the feature values are simulated under the each conditions, and
the each correlations are calculated for each of the conditions by using the fluctuation information and the feature value calculated under same condition.

20. A pattern shape predicting apparatus comprising:
an intensity-distribution calculating unit that predicts, with simulation, an intensity distribution of a pattern image concerning a pattern shape of a pattern on substrate formed on a substrate based on pattern data;
a first-pattern-edge-position calculating unit that calculates a first pattern edge position from the intensity distribution of the pattern image;
a feature-value calculating unit that calculates a feature value of the intensity distribution of the pattern image in a predetermined range including the first pattern edge position;
a fluctuation-amount calculating unit that calculates a fluctuation amount of the first pattern edge position from the feature value using a correlation; and
a second-pattern-edge-position calculating unit that predicts a second pattern edge position taking into account the fluctuation amount with respect to the first pattern edge position.
